(19) United States
(12) Patent Application Publication
(10) Pub. No.: US 2002/0182002 A1
(43) Pub. Date: Dec. 5, 2002

(54) 2004R billet intermediate shaft forward drum

(76) Inventor: Bruce Andrew Toelle, Sacramento, CA (US)

Correspondence Address: Bruce A. Toelle, 7850 Cucamonga Ave, # 31, Sacramento, CA, 95826, US

(21) Appl. No.: 09/872,911

(22) Filed: Jun. 4, 2001

(51) Int. Cl. B25G 3/28

(52) U.S. Cl. 403/359.1

(57) ABSTRACT

The 2004R Stock Intermediate Shaft Forward Drum is one of the parts in a 2004R Automatic Transmission. The factory Forward Drum is too weak for high performance or heavy duty uses. The factory Drum Shaft is removed and replaced with a Shaft made from a stronger metal. The NEW Shaft also has a collar added to one end for added strength and stability. The NEW Shaft is then welded into the Drum using a specific welding process. This process utilizes a special laser to do the welding and is performed in a vacuum-sealed receptacle. The holes around the Drum are enlarged to allow better oil circulation.

### BACKGROUND OF INVENTION

The 2004R Stock Intermediate Shaft Forward Drum is part of the 2004R Automatic Transmission that was designed by General Motors and used primarily in passenger vehicles.

The stock OEM factory Intermediate Drum and shaft is made from steel which is suitable for general purpose driving. The stock shafts are not able to hold the power (torque) generated by high performance and severe duty applications. Due to the increase in horsepower the stock shafts break at the spline tip under heavy loads.

The stock drums have lubrication holes but are too small to allow sufficient lubrication under increased loads (as in severe duty applications). These OEM drums also come with a plastic washer that sits on the inside of the drum. This washer (which is replaced with a metal roller bearing) is fine for normal use but under severe duty conditions it causes to much friction and breaks apart causing transmission failure.

### BRIEF SUMMARY OF THE INVENTION

Taking a Stock OEM Intermediate Shaft Forward Drum for a 2004R Automatic Transmission (FIG. 1, 1), removing the Stock Intermediate Shaft (FIG. 1, 2) and replacing it with a more durable shaft (FIG. 2, 2a) which also has a reinforcing collar added (FIG. 2, 3) at one end to reinforce the drum.

Shaft 2a is then grafted back into the drum (1) using a laser vacuum fusing procedure. The holes around the diameter of the drum (FIG 1, (4)) are enlarged to allow more lubrication.

### DESCRIPTION OF DRAWINGS

Page 6

FIG. 1—Shows the 2004R Intermediate Drum from a 45 degree and side view.

FIG. 1-1—Refers to the drum assembly.

FIG. 1-2—Is the Intermediate Shaft

FIG. 1-3—Points to the hole in which the old shaft is removed from and the new shaft is welded in.

FIG. 1-4—Is the section of the Intermediate Drum which shows the lubrication holes which are enlarged.

FIG. 1-5—Shows the Drum surface that is machined to fit a special roller bearing.

Page 7

FIG. 2—Shows a picture of the Stock/OEM Intermediate Shaft.

FIG. 2-a—Shows a picture of the New Intermediate Shaft.

FIG. 2-3—Shows placement of the added SPLINE section to the new shaft.

### DESCRIPTION OF INVENTION

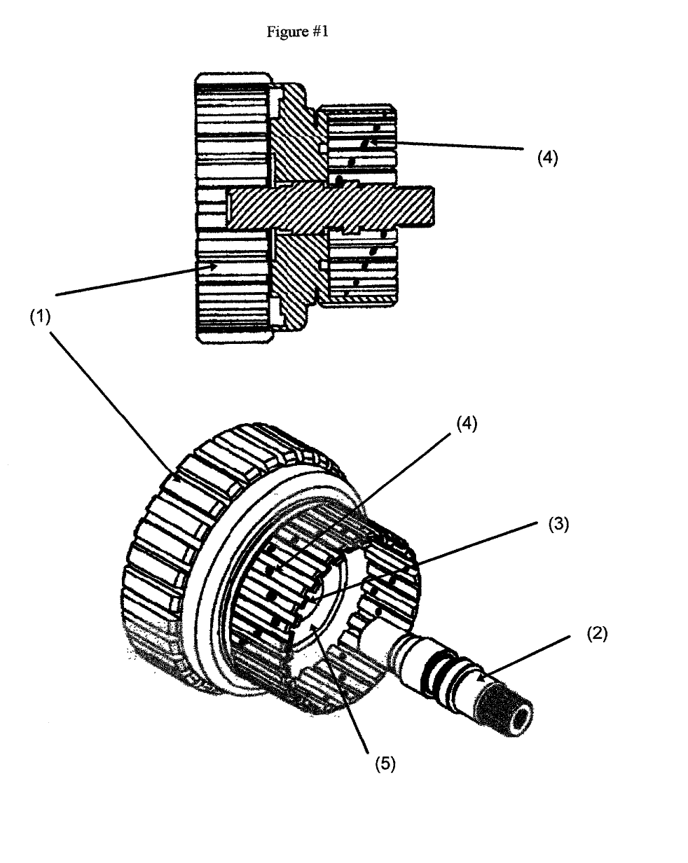

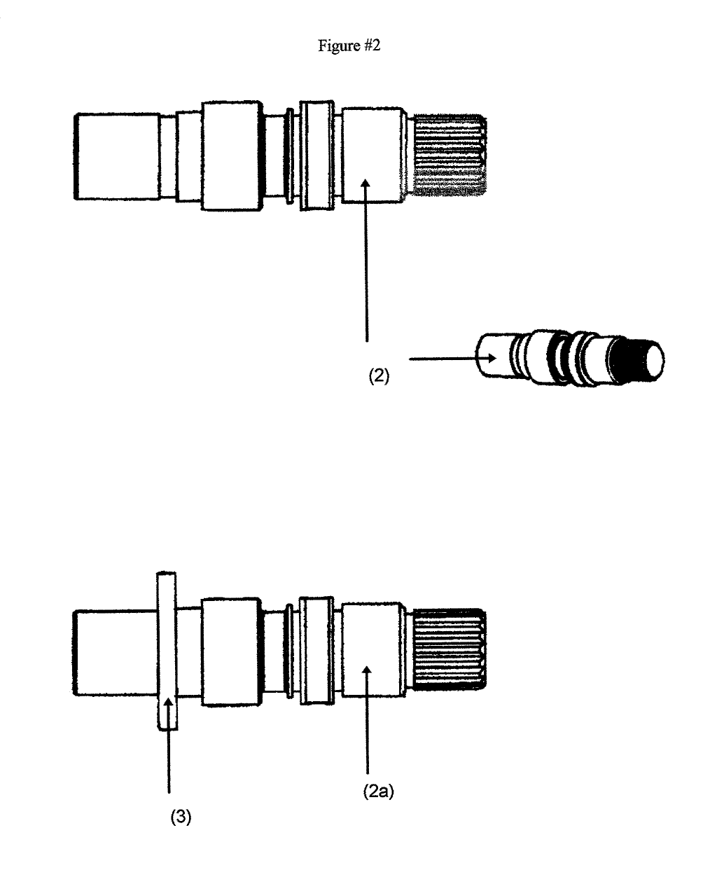

Taking a Stock OEM Intermediate Shaft Forward Drum for a 2004/R Automatic Transmission (FIG. 1, [1]) and removing the stock intermediate shaft (FIG. 1, [2]) and discarding it. Metal is fused into the hole (FIG. 1, [3]) for reinforcement. The stock shaft (FIG. 1, [2]) is replaced with a shaft (FIG. 2, [2a]) made from a more durable steel alloy and has a reinforcing collar added (FIG. 2, [3]) at one end for increased strength. The new shaft is then grafted into the drum using a laser vacuum fusing procedure.

Holes are enlarged all the way around the drum diameter to allow extra lubrication (FIG. 1, [4]). The inside surface of the drum (FIG. 1, [5]) is then retrofitted for a metal roller bearing that replaces the stock OEM plastic washer.

1: What I claim as my invention is the making of a more durable shaft from R434, a processed derivative of 300M steel.

2: What I claim as my invention is the reinforcing collar added at one end of the shaft.

3: What I claim as my invention is the enlargement of the lubrication holes on the side of the drum.
